(19) United States
(12) Patent Application Publication
(10) Pub. No.: US 2003/0221094 A1
(43) Pub. Date: Nov. 27, 2003

(54) Method and system for configuring a computer

(76) Inventor: Avery Pennarun, Westmount (CA)

Correspondence Address: Ogilvy Renault, Suite 1600, 1981 McGill College Avenue, Montreal, QC, H3A 2Y3, CA

(21) Appl. No.: 10/417,153

(22) Filed: Apr. 17, 2003

Related U.S. Application Data
(60) Provisional application No. 60/372,797, filed on Apr. 17, 2002.

(51) Int. Cl. G06F 15/177; G06F 9/24; G06F 9/00

(52) U.S. Cl. 713/1

(57) ABSTRACT

A computer system and system for configuring a computer is provided, particularly for computers coupled to a server on a network. A base operating system (OS) kernel is booted for execution by the computer, the base OS defining a kernelspace. A configuration application is booted for execution by the computer to manage the configuration, the configuration application defining a space between the kernelspace and a userspace defined by an OS distribution to be booted by said configuration. The configuration application may be directed by configuration information retrieved for said computer from a memory device coupled to the computer. The configuration information may be stored remotely and programmed for a particular computer using, for example, a configuration utility application. The configuration information can direct the specific computer to obtain a particular OS distribution stored on a network device coupled to the computer. The OS distribution may be obtained from a network file system and, if a version is stored to a local device coupled to the computer, the network and local versions may be one- or two-way synchronized. The OS distribution is rooted in a different root from the configuration application and isolated from modifying attributes of kernelspace. An unexpected OS booted on the computer may be detected automatically and distributed to a network memory device to facilitate redistribution to one or more computers on the network. The computer and others on the network having compatible hardware may be provided with one of a boot disk and a network interface device comprising a boot ROM configured to initiate the configuration steps automatically. User configuration may be templated for convenient and automatic configuration of applications to be executed in userspace on a per user basis. User changes may be preserved. New templates may be added. Users can update their respective template files while still receiving any updates installed by the system administrator. Templates may be structured for selective merging with system administrator changes and user changes may be overridden.

### CROSS-REFERENCE

This application claims priority from U.S. Provisional Application No. 60/372,797 filed Apr. 17, 2002.

### FIELD OF THE INVENTION

The present invention relates to computers coupled in a network and more particularly to the configuration of individual computers in the network.

### BACKGROUND

Computers such as a laptop computer, desktop, workstation, server and the like comprising a UNIX® or UNIX-like operating system (i.e. a UNIX system) can provide powerful functionality and allow for almost infinite customization. A UNIX and UNIX like operating system (OS) includes UNIX® (a registered trademark of the Unix System Laboratories, Inc.) and its variations such as BSD UNIX developed at UC Berkeley, and FreeBSD™ (a trademark of The FreeBSD Foundation); XENIX® (a registered trademark of Microsoft Corporation); LINUX® (a registered trademark of Linus Torvalds) and its variations, for example GNU™ (trademark of the GNU Project); and AIX® (a registered trademark of IBM), among others. However, the power and versatility of a UNIX system come at a price. A UNIX system takes significant resources to configure and to maintain.

For an organization that requires more than one UNIX system, for example for coupling in a network configuration, the resources required for configuration and maintenance multiply. It can thus become very expensive to run a network of UNIX systems despite the relatively low cost of the operating system, simply because of the support staff required. When a new UNIX system is introduced into the network it must have UNIX installed on it and then be configured in accordance with the requirements of the network and other preferences and needs of the organization. This can often lead to inconsistencies between machines and a variety of subtle problems can arise.

Some software packages exist that allow for installing software on one machine and then propagating it over the network to other systems. These packages, however, are not very flexible and require identical setups on each machine. They can also be difficult to set up and do not always perform as expected.

Settings that are specific for a system can be particularly problematic with a solution like this. If one system changes a network parameter such as its hostname or Internet Protocol (IP) address and these changes are propagated over the network, all systems on that network will try to make the same changes, resulting in numerous conflicts.

Other solutions such as ghosting of a server allow you to clone the initial setup of a server, but then there is no centralized way of doing updates. Ghosting also suffers from the same problem of having to manually adjust settings on each machine so that they don't conflict with the settings that are received from the ghosted image. Ghosting also requires a manual install of the ghosted image on each machine which can be quite time consuming.

Therefore there is a need for a solution which addresses some or all of these shortcomings.

### SUMMARY

In accordance with aspects of the invention a method, system and computer program product for configuring a computer are provided, particularly for computers coupled to a server on a network. A base operating system (OS) kernel is booted for execution by the computer, the base OS defining a kennelspace. A configuration application is booted for execution by the computer to manage the configuration, the configuration application defining a space between the kernelspace and a userspace defined by an OS distribution to be booted by said configuration. The configuration application may be directed by configuration information retrieved for said computer from a memory device coupled to the computer. The configuration information may be stored remotely and programmed for a particular computer using, for example, a configuration utility application. The configuration information can direct the specific computer to obtain a particular OS distribution stored on a network device coupled to the computer. The OS distribution may be obtained from a network file system and, if a version is stored to a local device coupled to the computer, the network and local versions may be one- or two-way synchronized. The OS distribution is rooted in a different root from the configuration application and isolated from modifying attributes of kernelspace. An unexpected OS booted on the computer may be detected automatically and distributed to a network memory device to facilitate redistribution to one or more computers on the network. The computer and others on the network having compatible hardware may be provided with one of a boot disk and a network interface device comprising a boot ROM configured to initiate the configuration steps automatically. User configuration may be templated for convenient and automatic configuration of applications to be executed in userspace on a per user basis. User changes may be preserved. New templates may be added. Users can update their respective template files while still receiving any updates installed by the system administrator. Templates may be structured for selective merging with system administrator changes and user changes may be overridden.

A better understanding of these and other aspects of the present invention can be obtained with reference to the following drawings and description.

### BRIEF DESCRIPTION OF THE DRAWINGS

The embodiments of the present invention will be explained by way of the following drawings, in which:

FIG. 1 schematically illustrates a computer embodying aspects of the invention;

FIG. 2 schematically illustrates in greater detail a portion of the computer of FIG. 1;

FIG. 3 illustrates in functional block form a portion of the memory illustrated in FIG. 2; and

FIG. 4 illustrates a flow chart of operations performed to distribute an operating system installed to a portion of the memory of FIG. 2;

FIG. 5 illustrates a flow chart of operations for a two-way synchronization of a portion of the memory of FIG. 2;

FIG. 6 illustrates a flow chart of operations for a user login; and

FIG. 7 illustrates schematically an exemplary grouping of user configuration template files.

Similar references are used in different figures to denote similar components.

### DETAILED DESCRIPTION OF THE PREFERRED EMBODIMENTS

The following detailed description of the embodiments of the present invention does not limit the implementation of the invention to any particular computer-programming language. The present invention may be implemented in any computer-programming language provided that the Operating System (OS) provides the facilities that may support the requirements of the present invention. A preferred embodiment is implemented in the C or C++ computer-programming language (or other computer-programming languages in conjunction with C/C++). Any limitations presented would be a result of a particular type of operating system or computer-programming language and would not be a limitation of the present invention.

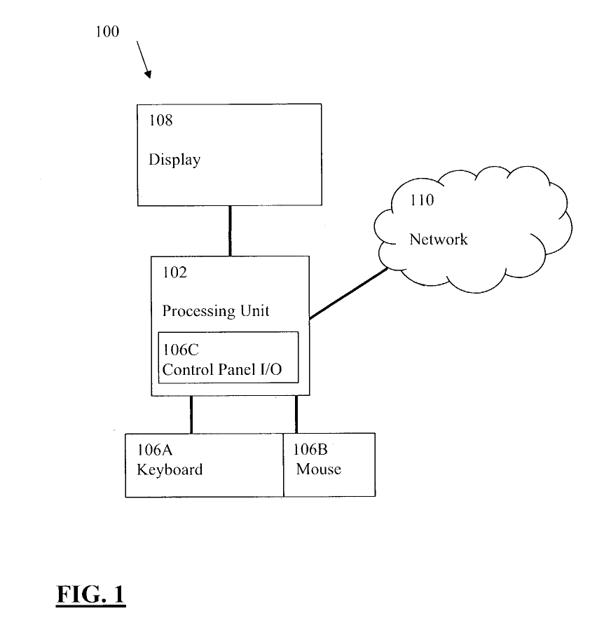

An embodiment of the invention, computer system 100, is illustrated in FIG. 1. Computer system 100 is adapted to communicate with other computing devices (not shown) using network 110. As will be appreciated by those of ordinary skill in the art, network 110 may be embodied using conventional networking technologies and may include one or more of the following: local networks, wide area networks, intranets, the Internet, and the like.

Through the description herein, an embodiment of the invention is illustrated with aspects of the invention embodied solely on computer system 100. As will be appreciated by those of ordinary skill in the art, those aspects of the invention may be distributed among one or more networked computing devices which interact with computer system 100, using one or more networks such as, for example network 110. However, for ease of understanding, aspects of the invention have been embodied in a single computing device, computer system 100.

Computing device 100 typically includes a processing system 102 that is enabled to communicate with the network 110, various input devices 106, and output devices 108. Input devices 106, (a keyboard and a mouse are shown) may also include a scanner, an imaging system (e.g., a camera, etc.), control panel buttons, or the like. Similarly, output devices 108 (e.g. video display as illustrated) may also include printers and the like. Additionally, combination input/output (I/O) devices may also be in communication with processing system 102. Computing device 100 is shown with an optional control panel I/O device 106C including control buttons and a liquid crystal display. Examples of conventional I/O devices (not shown in FIG. 1) include removable recordable media (e.g., floppy disk drives, tape drives, CD-ROM drives, DVD-RW drives, USB and other memory devices, etc.), touch screen displays, and the like.

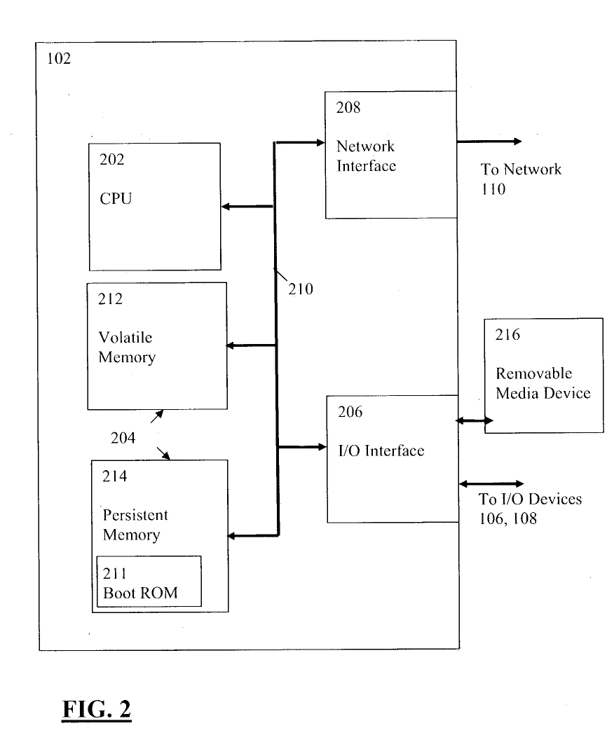

Exemplary processing system 102 is illustrated in greater detail in FIG. 2. As illustrated, processing system 102 includes a number of components: a central processing unit (CPU) 202; memory 204; I/O interface 206, network interface (I/F) 208 and removable media device 216. Communication between various components of the processing system 102 may be facilitated via a suitable communications bus 210 as required.

CPU 202 is a processing unit, such as an Intel Pentium™, IBM PowerPC™, Sun Microsystems UltraSparc™ processor, or the like, suitable for the operations described herein. As will be appreciated by those of ordinary skill in the art, other embodiments of processing system 102 could use alternative CPUs and may include embodiments in which more than one CPU is employed (not shown). CPU 202 may include various support circuits to enable communication between CPU 202 and the other components of processing system 102.

Memory 204 includes both volatile memory 212 and persistent memory 214 for the storage of: operational instructions for execution by CPU 202; data registers; application and thread storage; and the like. Memory 204 preferably includes a combination of random access memory (RAM), read only memory (ROM), and persistent memory such as that provided by a hard disk drive or other connected memory device such as a flash ROM (e.g. Boot ROM 211).

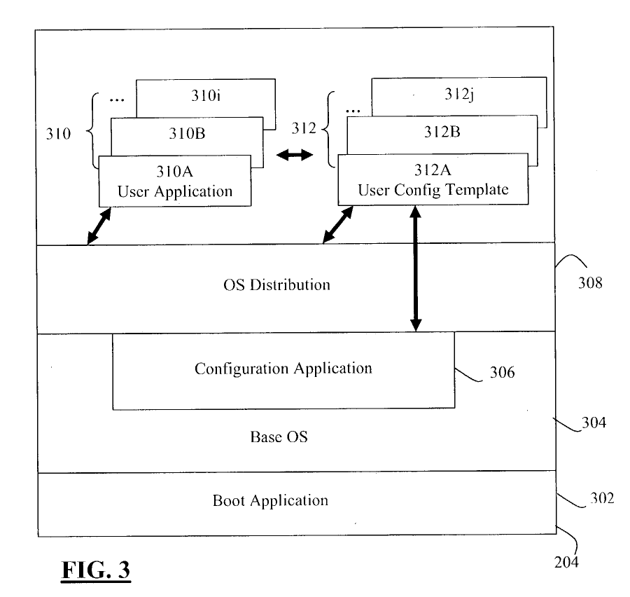

CPU 202 is typically coupled (to I/O Devices 106, 108 or Network 110) for receiving user and other commands for configuration of processing system 102 as well as for operation thereof. CPU 202 is coupled to memory 204 as described further with respect to FIG. 3 for containing an operating system and configuration parameters and files for the operating system as well as for applications or other programs enabled by the operating system to execute on CPU 202.

Network I/F 208 enables communication between other computing devices (not shown) via network 110. Network I/F 208 may be embodied in one or more conventional communication devices. Examples of a conventional communication device include: an Ethernet card; a token ring card; a modem, or the like. Network I/F 208 may also enable the retrieval or transmission of instructions for execution by CPU 202, from or to a remote storage media or device via network 110.

I/O interface 206 enables communication between processing system 102 and the various I/O devices 106 and 108. I/O interface 206 may include, for example a video card for interfacing with an external display such as output device 108. Additionally, I/O interface 206 may enable communication between processing system 102 and a removable media device. Removable media 216 may comprise a conventional diskette or other removable memory devices such as Zip™ drives, flash cards, CD-ROMs, static memory devices, and the like. Removable media 216 may be used to provide instructions for execution by CPUs 202 or as a removable data storage device or both.

The computer instructions/applications stored in memory 204 and executed by CPU 202 (thus adapting the operation of computer system 100 as described herein) are illustrated in functional block form in FIG. 3. As will be appreciated by those of ordinary skill in the art, the discrimination between aspects of the applications illustrated as functional blocks in FIG. 3 is somewhat arbitrary in that various operations attributed to a particular application or portion of memory 204 as described herein may, in an alternative embodiment, be subsumed by another application or portion of memory.

The programmed instructions may be embodied on a computer-readable medium (such as a hard disk, CD, floppy disk, flash or other memory device) which may be used for transporting the programmed instructions to the memory 204 of the computer system 100. Alternatively, the programmed instructions may be embedded in a computer-readable, signal-bearing medium that is uploaded to a network by a vendor or supplier of the programmed instructions and this signal-bearing medium may be downloaded to the computer system 100 from the network 110.

FIG. 3 illustrates memory 204 of FIG. 2 comprising a boot application 302, a base operating system 304, a configuration application 306; an OS distribution 308 comprising a UNIX or UNIX like OS, one or more user applications, 310A, 310B, . . . 310i, collectively 310 and one or more user configuration templates 312A, 312B, . . . 312j, collectively 312.

OS distribution 308 comprises a desired version of a UNIX or UNIX-like operating system for system 102 which may be distributed for all (or a selected some) of the computers on the network 110 in accordance with the invention as described further herein.

Software executing on a computer such as processing system 102 may be generally considered as divided into two parts: kernelspace and userspace. Kernelspace includes anything running inside the kernel, which is the core of the operating system. It is difficult to write code for the kernel and the kernel is usually restricted to handling the interaction of the components of the system with each other or components coupled thereto, for example, via network 110. Userspace is the general user level of a computer. Any user program that is run is a userspace program which interacts with kernelspace through system calls (syscalls). Userspace is generally less powerful, however it is easier and safer to program under. Kernelspace is generally more powerful, however programming in userspace is easier and safer. Programs running in kernelspace can crash the system, or overwrite important files, rendering it completely inoperable.

Programs that interact with a user are written for userspace. In accordance with the invention, there is provided an intermediate application for creating a notional program space between kernelspace and userspace referred to herein as an interspace. Interspace provides an abstracted interface for much of userspace's interaction with the kernel. Instead of userspace programs calling into the kernel directly through syscalls, these can be redirected to interspace where they may be handled differently. Interspace facilitates the setup of parts of userspace such as the network configuration while preventing actual userspace programs from changing such settings.

In general, interspace can take care of the setup process for system 102 automatically and then prevent userspace programs from changing particular setup configurations. In accordance with the invention, processing system 102 is configured with a boot application 302 for loading a base operating system 304 providing a kernel and a few utilities as described further below and a configuration application 306. Boot application 302 may be provided from boot ROM 211. Base OS 304 may be stored locally, for example, in boot ROM 211 or other persistent memory 214 or be obtained from a network file system coupled to system 102 as described further below.

It is anticipated that some particular processing systems 102 may not include a local hard drive. As such, local storage for operating system and configuration files may be limited. In accordance with the invention, configuration application supports a universal configuration file system (UniConf). Similar to a system registry or database repository used to store settings and options for the configuration of a particular computer with a selected OS, UniConf contains information and settings for all the hardware, software, users, and preferences of the system 102. UniConf is a centralized, hierarchical, structured, configuration system that instructs processing system 102 where to find files and other information to load and how to load it. A UniConf object can represent many different things, for example a local UniConf initialization (“ini”) file or a remote UniConf server, and is accessible via an application programming interface (API). A UniConf can even be composed of a list of different “generators” such as configuration or “ini” files or remote servers that are searched in priority sequence. UniConf can also provide default information.

UniConf is preferably represented as a tree structure with a text key matching to a text value. Each key can have sub keys and each sub key itself can have sub keys, representing a tree of unlimited depth. Importantly, UniConf allows a structured way to specify what should happen at boot time and, preferably, thereafter. UniConf may also include a notification feature so that if a change is made, for example, to a UniConf server from which processing system 102 obtains instructions, system 102 may be advised and can choose to either respond immediately or at its next boot. Response may be in accordance with a UniConf key/value received by system 102 from a UniConf server.

If a processing system 102 has a local storage such as a flash memory device and hard drive, then a copy of the UniConf tree for that system 102 may be stored locally so that if network 110 is not working or otherwise available at boot time, system 102 can still boot and use its previous setup.

Once base operating system 304 and configuration application 306 are loaded, configuration application operates to create the interspace between the kernelspace and userspace. Interspace is created by loading the desired OS distribution 308 typically from a remote source coupled via network 110 as described further below. OS distribution 308 is loaded in addition to base OS 304. As will be understood to persons skilled in the art, the chroot or change root command can be used to change the root reference location in the file system of system 102 to another directory for a given command. The chroot command is configured to shift the reference root of the target application (e.g. OS distribution 308) from the default root, restricting the target from being able to access or modify files or other information outside of its chroot environment.

By chrooting the init (startup) process of the OS distribution 308 and convincing it that it has process id 1, OS distribution 308 can be run in a chroot. Doing this from the boot of system 102 simulates a normal system boot of OS distribution 308 while having interspace remain beneath userspace for added functionality. As OS distribution 308 boots, it defines the userspace.

For the inti process of the OS distribution 308 to run and believe that it is the first process being run (i.e. that the system is just starting up now), the getpid( ) system call may be configured to return 1 to the inti process. Configuration application 306 is adapted to preload a version of the getpid( ) system call which returns 1 to any init processes and calls the actual getpid( ) syscall otherwise.

To facilitate one or more users on system 102, terminals or virtual terminals (ttys) are configured. To ensure the terminals are properly rooted, the command for setting terminals “getty” is chrooted as well. By having all of the ttys on the system 102 listen from within the chroot, the environment below the chroot (i.e. interspace) can be completely concealed from and inaccessible to the end user.

Configuration application 306 running from interspace can also automatically set up (i.e. configure as desired) a local hard drive, if available. Setup is not restricted to mounting it however, as the configuration application 306 is adaptable to replace the contents of the drive by remotely synchronizing the local drive to a desired file system located on a centralized server Such as a configuration master. This feature permits one centralized copy of an OS distribution to be customized and kept updated while having it deployed on many processing systems.

One UNIX utility that may be included in the base OS 304 is rsync for remote synchronization known to persons of ordinary skill in the art. Rather than have a scripted FTP session, or some other form of file transfer script, rsync is a utility that copies only the differences of files that have actually changed in two compared file structures. Further, copying over a network is performed in a compressed format to reduce bandwidth and, optionally, rsync operates through a secure shell (ssh). As such, only actual changed portions of files are transferred, rather than the entirety of each file. The portions are compressed, as needed, potentially saving transfer time. Ssh encrypts the transmission providing additional security.

Normally rsync is used to update part of a hard drive, but, in accordance with the invention, because the core of the base OS is protected, the entire hard drive may be overwritten. Configuration application 306 can rsync the hard drive from a remote server configured for rsync service to obtain the desired OS distribution 308 prior to performing the chroot and running init and getty. Rsync may be performed as frequently as every boot of system 102 to obtain the most current OS distribution. Since rsync only copies changes, network traffic is minimized and booting performance is maintained.

UniConf structures the rsync to indicate which files to rsync to where on the local hard drive. UniConf may be maintained on a remote server such as the configuration master. A convenient interface such as a web interface to the configuration master may be provided to an administrative user, for example, to enable the editing of UniConf information to specify which systems 102 should receive which OS distributions 308. Systems 102 may be identified by their respective hostnames or other network identifier, for example. When a particular system 102 boots, its configuration application 306 may direct a connection to a configuration master as a UniConf server and request a location identifier (e.g. URL) for the OS distribution 308 to mount. If no specific OS distribution 308 is specified for a given system, a default may be applied.

In addition to synchronizing in an OS distribution 308, configuration application 306 may be adapted to distribute a locally stored operating system (not shown) for creating a master OS for distribution to other systems. For example, system 102 can be booted from a CD-ROM or local hard disk with a desired operating system installed on it. This OS, once configured may be synchronized out to create an OS distribution copy. The configuration application 306 may be installed and initiated. When system 102 is rebooted again, the configuration application will be initiated at boot time and identify that a new (i.e. local) operating system has been installed. To detect different OSes, each hard drive in a system 102 is formatted with the first partition used to store the information about what the hard disk is and what it should contain. Because this partition has a known file system, size, and expected files, it can be easily determined by a configuration application 306 if a new (i.e. unexpected) OS has been installed on the drive. This new OS can then be synchronized over to a configuration master server for storage and distribution out to one or more other systems 102. The copied OS may be stored in association with a unique identifier such as a globally unique identifier (GUID) for identification. A user may also name an OS distribution for easier reference, if desired.

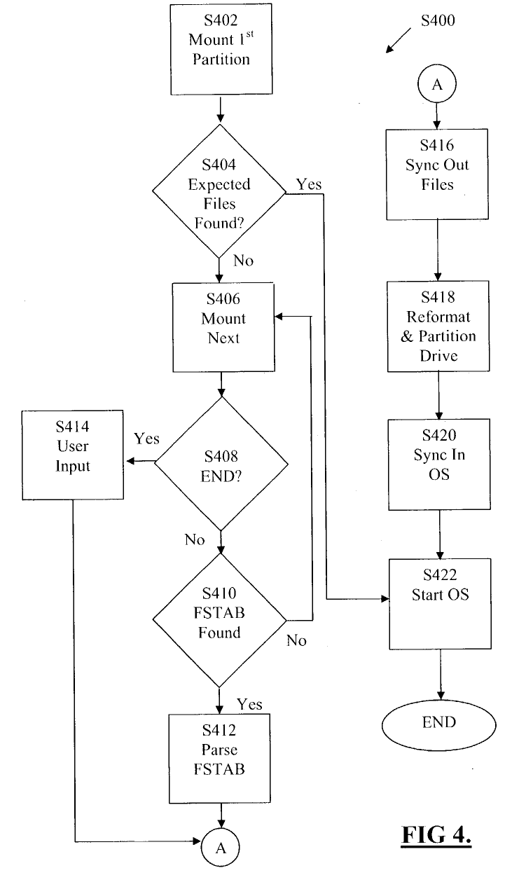

FIG. 4 shows a flow chart of operations S400 to check the integrity of a local hard drive to see if it contains a known OS or an OS to distribute. Such a disk integrity check may be performed at each boot before chrooting the init process of OS distribution 308 away from interspace.

At S402, disk integrity operations mount the local hard drive's first partition. At S404, the partition is inspected to determine whether it comprises the expected files for a known OS distribution. If expected files are located, operations skip to S422. Otherwise, at S406 and S408, mounting of the remaining partitions is attempted and noted and for those that are mountable, each partition is evaluated to find one that contains a table of file system information (e.g. /fstab or /etc/fstab) S410.

At S412 file system information is parsed to determine file system structure among the partitions. At S416, starting with the partition that contains/(i.e. the root), the file system is copied via rsync in association with a newly generated GUID to the configuration master server. Operations then continue at S418.

If at S408, no fstab is found in all the partitions and if there is more than one partition with file contents then user input may be sought (S414). Contents of each partition may be copied via rsync to the configuration master server in any event (S416).

At S418, once the files on the hard disk have been distributed, and assuming that UniConf has specified that this process should be automatic, the local hard drive is reformatted and partitioned to follow configuration application standards for known OS distributions (i.e. setting up the first partition with appropriate known files and file system). The OS that was distributed may then be synchronized from the configuration master server back to the main file system partition (S420).

Following S420, system 102 is configured with the configuration application and the desired version of the OS distribution in a form that may be initiated following a chroot and with an appropriately configured getpid( ) (S422).

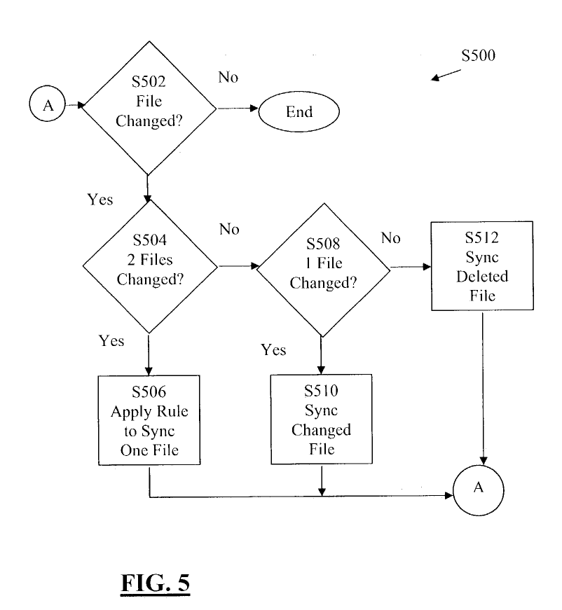

Instead of just synchronizing the (userspace) file system from system 102 to a remote server, or more typically from a remote server to system 102, two-way synchronizations may be performed so that updates are passed either way. In this way, updates are not lost. FIG. 5 shows the optional operations S500 of two way synchronization.

At S502, for each file, a determination is made whether either system 102 or the remote server has changed a file. To facilitate a change determination, files may be stored in association with a timestamp and, preferably a unique identifier based upon the contents of the file such as a message digest value determined in accordance with a message digest mechanism such as MD5 or similar functions. At S504, if both of the system 102 and remote server changed the file, a rule may be applied to select which file will be kept in preference to the other (S506). One rule may prefer local users over system administrators, another the opposite and yet a third may select based upon a time of the change, with the earlier or later update prevailing. User input could also be sought. At S508, if only one changed the file, the change may be copied via rsync to the other (S510). Otherwise, the change must be a deletion by one or the other. A synchronization of the deleted file on the other may be performed (S512). Operations return from S506, S510 and S512 to S502 to determine if more files have changed.

Configuration application 306 can be adapted to facilitate the remote configuration of system 102 from a configuration master server to use any OS distribution that has been installed to the server facilitating quick and efficient cloning of systems 102. At the same time, customization is still possible using the various forms of synchronization.

As is known to persons skilled in the art, each system 102 may be identified by its hostname or its Internet Protocol (IP) address on network 110 where network 110 is configured as an IP network. Systems 102 may be configured, for example, to automatically obtain their respective IP address from a network server providing dynamic host configuration protocol (DHCP) services for the network 110. IP addresses may also be assigned statically. A system's IP address may be displayed on its control panel I/O device 106C to provide convenient notification of the identifier to a user for configuring the configuration master server. With this identifier, a hostname (a convenient representation of the IP address) can be assigned in the configuration master server's web configuration interface.

The web configuration interface on the configuration master server can then be used to, for example, identify “hostname” to the server as a system to receive an OS distribution. UniConf on the server will in turn send a message (UniConf key/value) to “hostname” to instruct system 102 to seek the OS distribution upon a boot of that system. A UniConf key/value message can also indicate that this boot should occur immediately, if desired.

System 102, when rebooted, then reloads its UniConf tree of key/values which instructs system 102 with the location of the network drive with which the local hard drive is to rsync (or to network mount that network drive if there is no hard drive). Following these operations, system 102 becomes a network-configured system with the desired OS distribution 308 and may be initiated as previously described.

Configuration application 306 can be loaded into system 102 by network booting. Base OS 304 (i.e. the kernel) and then the configuration application 306 may be loaded from a boot disk or a boot ROM (which may form part of a network I/F device 208). If the system 102 has a hard drive it may be automatically detected and used by configuration application 306. If system 102 does not have a local hard drive, then configuration application 306 may be configured to use a network file system (NFS) identified by the base OS instead and the system 102 can still be fully functional. The identified OS distribution is then obtained by the configuration application 306.

In addition to configuring an operating system (OS distribution 308) for each system 102, configuration application 306 facilitates a templated user file system so that each individual user can have configuration files automatically generated for particular users application. The user applications are typically installed on network system-wide basis (i.e. are available to user systems such as system 102 from a server). Configuration files for each user application can be templated and stored in a template directory from which they can be automatically copied or customized and copied, as necessary, to a particular user's directory.

A template requiring customization to identify a particular user may be run through a filter to replace user-specific parts with the correct information before being installed for the particular user. Template files not requiring user-specific part replacement may be simply installed into a user's home directory which may be a mount over NFS or a local drive relative to system 102.

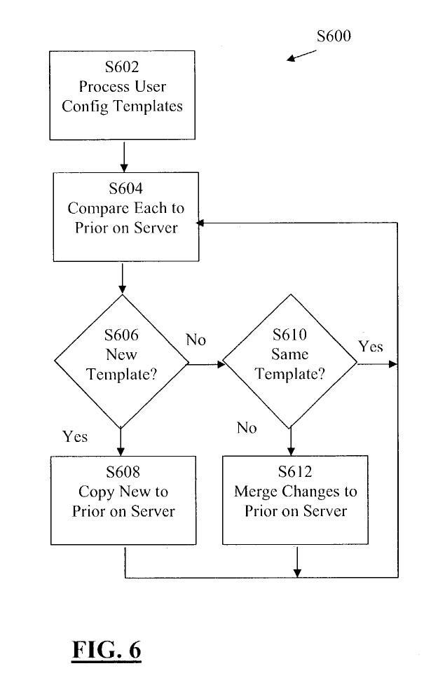

By installing appropriate templates at each login, the user's environment is always fully configured. FIG. 6 illustrates a flowchart of operations S600 for a user login in accordance with the invention.

Any user configuration template file that requires user customization is preprocessed to generate a user configuration template file 312. At S602, processing may be performed using standard regular expression substitution, for example, have OS substitution editor utility “sed” replace %%%%USER%%%% with the current username, etc. At S604, each user config template file 312 (generated by preprocessing or not) is compared with its corresponding user config template file stored in the user's personal template directory on the configuration master server. Because file comparison operations perform relatively slowly for a login, datestamps may be compared, working under the assumption that if the modification time is exactly the same it is most likely the exact same file. At S606, S608, if a particular user config template file 312j does not exist in the user's personal template directory, the new file is copied to the user's personal template directory and preferably to the user's home directory at system 102. The datestamp is matched with that of the original template (S608). Otherwise, at S610, if the file is the same as the one in the template directory, nothing happens and operations return to S604. Otherwise, at S612, if the file is different from the one in the template directory, a file merge is performed to merge preferences selected by the user with new configuration information added by and administrative user. Such a file merge may be performed using a three-way difference utility, such as diff3 known to persons of ordinary skill in the art.

The template operations can be enhanced by keeping a copy of the installed templates locally in a user's home directory, where possible. By doing three-way differences between the user's local version, the templated version, and a previous template version stored remotely, updates may be automatically performed without removing a user's customization. The templates stored in the user's directory are then updated with the new global template version so that the merge is not done repeatedly.

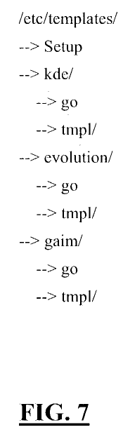

The templates do not necessarily need to be installed over a user's settings. Instead, the user can selective choose which configurations to update and/or override in order to gain any updates and to fix anything that has gone wrong. This can be accomplished by separating the template files into categories. Each template directory contains files for a certain user application grouping. For example, each application can have a separate sub directory in the overall template directory. An exemplary template directory structure is illustrated in FIG. 7.

A template setup mechanism in configuration application 306 may comprise a simple shell script that performs a for loop for every folder and subfolder of the template directories, running each “go” script located therein. Each go script can then be customized to do any extra configuration needed as well as running the main template program which does the procedure outlined earlier on the template directory given the destination directory/name. Optionally, the setup shell may be adapted with a parameter indicating a specific segment of the directories to setup or a flag to force an override, for example.

By having network boot images that load configuration application 306 for configuring OS distribution 308 and user files such as applications 310 and configuration templates 312, system 102 can be installed and set up with minimal input from the administrator and none from the end user. However, by providing an end user with templates that may be modified and merged, user customizations may be maintained. Remote storage of OS distribution 306 and customizations (user configuration templates 312 etc.) permits a particular end user to login at any system 102 connected to the configuration master server and have the user's customizations automatically configure system 102.

It will be appreciated that variations of some elements are possible to adapt the invention for specific conditions or functions. The concepts of the present invention can be further extended to a variety of other applications that are clearly within the scope of this invention. Having thus described the present invention with respect to one or more embodiments as implemented, it will be apparent to those skilled in the art that many modifications and enhancements are possible to the present invention without departing from the basic concepts as described in the preferred embodiment of the present invention. Therefore, what is intended to be protected by way of letters patent should be limited only by the scope of the following claims.

I claim:

1. A method for configuring a computer comprising:
booting a base operating system (OS) kernel for execution by the computer, said base OS defining a kernelspace;
booting a configuration application for execution by the computer to manage the configuration of said computer, said configuration application defining a space between said kernelspace and a userspace defined by an OS distribution to be booted by said configuration; and
managing the configuration of said computer using said configuration application.

2. The method of claim 1 comprising obtaining configuration information for said computer from an information repository coupled to the computer, said configuration application adapted to manage in response to said configuration information.

3. The method of claim 2 wherein the information repository is coupled via a network.

4. The method of claim 1 wherein the step of managing comprises booting the OS distribution for said computer from a memory device coupled to the computer.

5. The method of claim 4 wherein said memory device comprises a local memory device coupled locally to the computer and wherein said computer is coupled to a network memory device via a network, said network memory device storing the OS distribution for said booting the OS distribution; and wherein said booting the OS distribution comprises distributing the OS distribution for said computer to said local memory device in response to a content of the local memory device.

6. The method of claim 5 wherein the content of the local memory device comprises a previous OS distribution distributed to said computer; and wherein said step of distributing comprises one of a one-way and a two-way synchronization of the OS distribution between the local memory device and the network memory device.

7. The method of claim 4 wherein the step of booting an OS distribution comprises rooting said OS distribution to a root different from a root of the configuration application.

8. The method of claim 7 wherein the step of rooting is adapted to isolate said OS distribution and any userspace defined thereby from modifying attributes of kernelspace.

9. The method of claim 1 comprising:
booting an unexpected OS for execution by said computer;
detecting said unexpected operating system using said configuration application; and
distributing said unexpected OS to a network memory device coupled to the computer via a network for subsequent distribution as an OS distribution to one or more computers coupled to said network memory device.

10. The method of claim 3 comprising defining said configuration information for said computer, said configuration information associated with said computer by an identifier for said computer said configuration information defined to adapt said configuration application to obtain a particular OS distribution from one of a plurality of OS distributions prepared using one or more other computers coupled to the network.

11. The method of claim 4 comprising providing each of said computer and one or more other computers coupled to said network and having compatible hardware with one of a boot disk and a network interface device comprising a boot ROM configured to initiate said steps automatically to create similarly configured computers on said network.

12. The method of claim 1 comprising:
storing to a network memory device coupled to said computer one or more user configuration templates for one or more applications to be executed in said userspace; and
wherein the step of managing comprises:
obtaining said user configuration templates; and
configuring said computer in response to said user configuration templates.

13. The method of claim 13 wherein the step of managing further comprises adapting at least some of said user configuration templates in response to an identification of a particular user using said computer; and wherein said step of configuring is responsive to said adapted user configuration templates.

14. The method of claim 13 comprising:
maintaining a plurality of versions of said user configuration templates, said versions comprising an administrator version including recent changes to said user configuration templates made by an administrator; a user version including recent changes made by said user; and a past merged version including a merge of past changes made by said user and said administrator;
merging said plurality of versions to create a new past merged version; and
using said new past merged version in said step of configuring.

15. The method of claim 14 wherein said step of merging comprises selectively merging particular user configuration files.

16. The method of claim 15 wherein said merging comprises overriding one or more changes made by a user.

17. The method of claim 13 comprising providing each of said computer and one or more other computers coupled to said network and having compatible hardware with one of a boot disk and a network interface device comprising a boot ROM configured to initiate said steps automatically to create similarly configured computers on said network.

18. A computer program product embodied in a computer readable medium for configuring a computer, said product comprising computer executable code to:
boot a base operating system (OS) kernel for execution by the computer, said base operating system defining a kernelspace;
boot a configuration application for execution by the computer to manage the configuration of said computer, said configuration application defining a space between said kernelspace and a userspace defined by an OS distribution to be booted by said configuration; and
manage the configuration of said computer using said configuration application.

19. The computer program product of claim 18 comprising computer executable code to obtain configuration information for said computer from a memory device coupled to the computer, said configuration application adapted to manage in response to said configuration information.

20. The computer program product of claim 19 wherein the memory device is coupled via a network.

21. The computer program product of claim 18 wherein the computer executable code to manage comprises computer executable code to boot the OS distribution for said computer from a memory device coupled to the computer.

22. The computer program product of claim 21 wherein the said memory device comprises a local memory device coupled locally to the computer and wherein said computer is further coupled to a network memory device via a network, said network memory device storing the OS distribution for said booting the OS distribution; and wherein said computer executable code to boot the OS distribution comprises computer executable code to distribute the OS distribution for said computer to said local memory device in response to a content of the local memory device.

23. The computer program product of claim 22 wherein the content of the local memory device comprises a previous OS distribution distributed to said computer; and wherein said computer executable code to distribute is adapted for one of a one-way and a two-way synchronization of the OS distribution between the local memory device and the network memory device.

24. The computer program product of claim 21 wherein the computer executable code to boot the OS distribution is adapted to root said OS distribution to a root different from a root of the configuration application.

25. The computer program product of claim 24 wherein the computer executable code is adapted to isolate said OS distribution and any userspace defined thereby from modifying attributes of kernelspace.

26. The computer program product of claim 18 comprising computer executable code to:
boot an unexpected OS for execution by said computer;
detect said unexpected operating system using said configuration application; and
distribute said unexpected OS to a network memory device coupled to the computer via a network for subsequent distribution as an OS distribution to one or more computers coupled to said network memory device.

27. The computer program product of claim 20 comprising computer executable code to define said configuration information for said computer, said configuration information associated with said computer by an identifier for said computer, said configuration information defined to adapt said configuration application to obtain a particular OS distribution from one of a plurality of OS distributions prepared using one or more of a plurality of computers coupled to the network.

28. The computer program product of claim 21 wherein the medium comprises one of a boot disk and a network interface device comprising a boot ROM for each of said computer and one or more other computers coupled to said network and having compatible hardware, said medium adapted to initiate said computer executable code at boot time automatically.

29. The computer program product of claim 18 wherein the computer is coupled to a network memory device storing one or more user configuration templates for one or more applications to be executed in said userspace; and wherein the computer executable code to manage is adapted to:
obtain said user configuration templates; and
configure said computer in response to said user configuration templates.

30. The computer program product of claim 29 wherein the computer executable code to manage is further adapted to change at least some of said user configuration templates in response to an identification of a particular user using said computer; and wherein said computer executable code to manage is further adapted to configure in response to said changed user configuration templates.

31. The computer program product of claim 30 comprising computer executable code to:
maintain at least two versions of said user configuration templates, said versions comprising a user version including recent changes made by said user; and a past merged version including a merge of past changes made by said user and an administrator;
merge said at least two versions and an administrator version including recent changes to said user configuration templates made by an administrator to create a new past merged version; and
use said new past merged version to configure said computer.

32. The computer program product of claim 31 wherein said computer executable code to merge is adapted to selectively merge particular user configuration files.

33. The computer program product of claim 32 wherein said computer executable code to merge is adapted to override one or more changes made by a user.

34. The computer program product of claim 30 wherein the medium comprises one of a boot disk and a network interface device comprising a boot ROM adapted for each of said computer and one or more other computers coupled to said network and having compatible hardware, said medium adapted to initiate said computer executable code at boot time automatically.

35. A computer system comprising a processing unit and a memory coupled thereto, the memory storing computer executable code for configuring the computer system, the code comprising:
a base operating system (OS) kernel for execution by the computer, said base OS defining a kernelspace;
a configuration application for execution by the computer to manage the configuration of said computer, said configuration application defining a space between said kernelspace and a userspace defined by an OS distribution to be booted by said configuration.

36. The computer system of claim 35 comprising code for obtaining configuration information for said computer from an information repository coupled to the computer, said configuration application adapted to manage in response to said configuration information.

37. The computer system of claim 36 wherein the information repository is coupled via a network.

38. The computer system of claim 35 wherein the configuration application is adapted to boot the OS distribution for said computer from a memory device coupled to the computer.

39. The computer system of claim 38 wherein said memory device comprises a local memory device coupled locally to the computer system and wherein said computer system is coupled to a network memory device via a network, said network memory device storing the OS distribution for booting by said configuration application; and wherein said configuration application is adapted to obtain to said local memory device in response to a content of the local memory device the OS distribution for booting to said computer.

40. The computer system of claim 39 wherein the content of the local memory device comprises a previous OS distribution distributed to said computer; and wherein said configuration application is adapted for one of a one-way and a two-way synchronization of the OS distribution between the local memory device and the network memory device.

41. The computer system of claim 38 wherein the configuration application is adapted to root said OS distribution to a root different from a root of the configuration application.

42. The computer system of claim 41 wherein the configuration application is adapted to isolate said OS distribution and any userspace defined thereby from modifying attributes of kernelspace.

43. The computer system of claim 35 comprising:
an unexpected OS booted for execution by said computer; and
wherein said configuration application is adapted to detect said unexpected operating system; and
distribute said unexpected OS to a network memory device coupled to the computer via a network for subsequent distribution as an OS distribution to one or more computers coupled to said network memory device.

44. The computer system of claim 37 wherein said configuration information is associated with said computer by an identifier for said computer and wherein said configuration information is defined to adapt said configuration application to obtain a particular OS distribution from one of a plurality of OS distributions prepared using one or more other computers coupled to the network.

45. The computer system of claim 38 comprising one of a boot disk and a network interface device comprising a boot ROM configured to initiate said code automatically.

46. The computer system of claim 38 wherein said computer system is coupled to a network memory device storing one or more user configuration templates for one or more applications to be executed in said userspace; and wherein the configuration application comprises code for:
obtaining said user configuration templates; and
configuring said computer system in response to said user configuration templates.

47. The computer system of claim 46 wherein the configuration application comprises code for adapting at least some of said user configuration templates in response to an identification of a particular user using said computer system; and wherein said configuring is responsive to said adapted user configuration templates.

48. The computer system of claim 47 wherein said code comprising code to:
maintain at least two versions of said user configuration templates, said versions comprising a user version including recent changes made by said user; and a past merged version including a merge of past changes made by said user and an administrator;
merge said at least two versions and an administrator version coupled to said computer and including recent changes to said user configuration templates made by an administrator, said merge to create a new past merged version; and
use said new past merged version to configure said computer.

49. The computer system of claim 48 wherein said code to merge is adapted to selectively merge particular user configuration files.

50. The computer system of claim 49 wherein said code to merge is adapted to override one or more changes made by a user.

51. The computer system of claim 46 comprising one of a boot disk and a network interface device comprising a boot ROM configured for each of said computer and one or more other computers coupled to said network and having compatible hardware, said one of a boot disk and boot ROM comprising boot code to initiate the boot of said base OS and configuration application automatically to create similarly configured computers on said network.

52. A computer server for serving a computer coupled thereto, said computer comprising a base operating system (OS) kernel for execution by the computer, said base operating system defining a kernelspace and a configuration application for execution by the computer to manage the configuration of said computer, said configuration application defining a space between said kernelspace and a userspace defined by an OS distribution to be booted by said configuration application, said server comprising:
a configuration information repository for providing configuration information to said computer, said configuration application adapted to manage the configuration of said computer in response to said configuration information.

53. The computer server of claim 52 comprising at least one OS distribution, said server distributing a particular OS distribution to said computer in response to said configuration information for said computer, said particular OS distribution to be booted by said configuration application.

54. The computer server of claim 53 wherein the server comprises executable code adapting said server to synchronize the particular OS distribution to be distributed to the computer with a previously distributed OS distribution stored to a memory device coupled to said computer.

55. The computer server of claim 54 wherein code is adapted for at least one of a one-way and a two-way synchronization of the OS distribution to be distributed.

56. The computer server of claim 53 comprising computer executable code to store an unexpected OS booted for execution by said computer and detected by said configuration application; said server receiving and subsequently distributing said unexpected OS as an OS distribution to one or more computers coupled to said server.

57. The computer server of claim 52 comprising computer executable code to define said configuration information for said computer, said configuration information associated with said computer by an identifier for said computer, said configuration information defined to adapt said configuration application to obtain a particular OS distribution from one of a plurality of OS distributions prepared using one or more of a plurality of computers coupled to the server.

58. The computer server of claim 53 comprising one or more user configuration templates for one or more applications to be executed in said userspace; said server adapted to provide said user configuration templates to said computer.

59. The computer server of claim 58 comprising an administrator version of said user configuration templates including recent changes made by an administrator; a user version of said user configuration templates including recent changes made by said user; and a past merged version of said user configuration templates including a merge of past changes made by said user and an administrator; and wherein one of said server and said computer adapted to merge said versions to create a new past merged version; and wherein said computer adapted to use said new past merged version to configure said computer.
